(19) United States
(12) Patent Application Publication
(10) Pub. No.: US 2006/0010320 A1
(43) Pub. Date: Jan. 12, 2006

(54) METHOD OF SECURE DATA EXCHANGE

(75) Inventor: Chenming Chuang, Taipei City (TW)

Correspondence Address: CONNOLLY BOVE LODGE & HUTZ LLP, SUITE 800, 1990 M STREET NW, WASHINGTON, DC, 20036-3425, US

(73) Assignee: LEADTEK RESEARCH INC., Chung Ho City (TW)

(21) Appl. No.: 10/710,426

(22) Filed: Jul. 9, 2004

(51) Int. Cl. H04L 9/00

(52) U.S. Cl. 713/168

(57) ABSTRACT

A method of secure data exchange is applied to a system that includes a server and at least a client. After starting to first connect to the server, the client sends a reset message to the server using an initial key. Once receiving the message, the server verifies the received messages and also uses the initial key to decrypt them. If the verification of the messages is approved, the server generates a first key and sends a key exchange message, which includes the first key and is encrypted by the initial key to the client. Afterward, the client replaces the initial key with the first key in response to the received key exchange message, and meanwhile returns a key confirmation message. If the key confirmation message is approved, the server sends a downloading message to allow the client to retrieve corresponding information. After the information is successfully downloaded, the client sends a finish message to notify the server to await the coming of a next session.

### BACKGROUND OF THE INVENTION

The present invention relates to a method of secure data exchange, and more particularly to an encryption key exchange between two cryptographic units.

Two mutually exclusive classes of cryptographic methods and protocols are well known to those familiar with cryptography, symmetric cryptography, and public-key cryptography (or named asymmetric cryptography). In symmetric cryptographic protocols, the same key and cryptographic method are used both for encrypting a plaintext into cyphertext and for decrypting a cyphertext to recover the plaintext. It is readily apparent that the security of a symmetric cryptographic protocol can never exceed the security of the single key used for both encryption and decryption.

For symmetric cryptographic protocols, there are three well-known key management problems. First, a key may be compromised, which permits an eavesdropper who obtains the key either to read all the cyphertext or even to broadcast bogus cyphertext. The only way to alleviate this problem is to change the key frequently. A second problem for symmetric cryptography key management is that it requires a large number of keys if each pair of individuals in a group is to communicate with each other using a different key. Forty-five unique keys are required if a group of 10 individuals are to communicate. Fifty-five unique keys are required for communication among a group of 11 individuals. The final problem for key management in symmetric cryptographic protocols is that, since the keys are more valuable than the encrypted message, the keys must be exchanged by a secure communication.

Whether used with a symmetric cryptographic protocol or with a public-key cryptographic protocol, an encryption key should not be used indefinitely. First, the longer time a key is used for, the more likely it will be comprised by theft, luck, extortion, bribery or cryptanalysis. Longer use of a key aids an eavesdropper because it provides more cyphertext encoded with the same key to which cryptanalytic methods may be applied. Second, usually the longer time a key is used for, the greater loss the key must compromise on.

### SUMMARY OF THE INVENTION

The primary objective of the present invention is to provide a method of secure data exchange, which is secure against cryptanalysis. The method is based on the exchange of cryptographic keys between two cryptographic units. Because a new key replaces a previous key during every session, an eavesdropper steals too little cyphertext to complete cryptanalysis.

Another objective of the present invention is to provide a cryptographic key exchange protocol that is simpler than the present protocols.

In order to achieve the objective, the present invention discloses a method of secure data exchange occurring in a system that includes a server and at least a client. An initial key is either pre-configured by factories and permanently stored in the client (or named as an endpoint) or obtained from the server through a manual login. After starting to first connect to the server, the client sends a reset message to the sever using the initial key. Once receiving the message, the server verifies the received messages and also uses the initial key to decrypt them. If the verification of the messages is approved, the server generates a first key and sends a key exchange message that includes the first key and is encrypted by the initial key to the client. Afterward, the client replaces the initial key with the first key in response to the received key exchange message, and meanwhile returns a key confirmation message. If the key confirmation message is approved, the server sends a downloading message to allow the client to retrieve corresponding information. After the information is successfully downloaded, the client sends a finish message to notify the server to await the coming of a next session.

When the next session starts, the client sends a key validation message encrypted by the first key. If the key validation message is approved, the server grants the request of the client to send another key exchange message with a second key. Conversely, the initial key is still used to request the approval of the server.

### BRIEF DESCRIPTION OF THE DRAWINGS

The invention will be described according to the appended drawings in which:

FIG. 1 is a diagram of message transition between two cryptographic units in accordance with the preferred embodiment of the present invention;

FIG. 2 is a diagram of message transition between two cryptographic units in accordance with the preferred embodiment of the present invention;

FIG. 3 is a diagram of message transition between two cryptographic units in accordance with the preferred embodiment of the present invention;

FIG. 4 is a diagram of message transition between two cryptographic units in accordance with the preferred embodiment of the present invention;

FIG. 5 is a diagram of message transition between two cryptographic units in accordance with the preferred embodiment of the present invention; and

FIG. 6 is a diagram of state transitions regarding the server in accordance with the present invention.

### PREFERRED EMBODIMENT OF THE PRESENT INVENTION

In an automatic provisioning system (APS), clients can obtain all configuration data from an automatic provisioning server, and all communication including the configuration data between them is encrypted and secure against any eavesdropper. Two entities are involved in the system, one being a key distribution server (KDS) which holds all client's profiles and cryptographic information, such as key information, and the other being the endpoints (EPs) maintained by the clients. Furthermore, the KDS can be integrated into the automatic provisioning server.

The KDS, acting as a powerful server, holds clients' personal data and execute complicated encryption and decryption processes. Generally speaking, the computational capability and storage capacity of EPs are limited by themselves. Therefore, the present invention discloses that a method improves the security of data exchange between the two entities regardless of the enhancement of the EPs' performance.

The following notations are used to explain the key distribution mechanism of a KDS in response to the requirement of an EP:

S(i) denotes the states of the i-th endpoint (EPi) monitored by the KDS;

K(i) denotes the key held by the EPi;

RK(i) denotes an initial key stored in the EPi;

AK(i) denotes a current active key held by the KDS;

CK(i) denotes a next key designated by the KDS; and

MAC(i) denotes the MAC (Media Access Control) address of the EPi.

There are four states of the EPi monitored by the KDS. First, an inactive state means the EPi is not recognized by the KDS; an exchanging state means a key exchange occurs between them; an idle state means the EPi is recognized by the KDS and awaits the coming of a next event initialized by either itself or the KDS; finally, a downloading state means the KDS allows the EPi to download data from somewhere that is authorized. In summary, the definitions of all messages occurring between the EPs and KDS are summarized in Table 1.

TABLE 1
Definition
of Mes-
sages

| Name | Initiator | Description |
|---|---|---|
| RESET | EP | Reset a current key for the EP. |
| KEY_EXCHANGE | KDS | Distribute a new key. |
| KEY_CONFIRM | EP | Confirm if a current key is re- |
| | | ceived. |
| KEY_VALIDATE | EP | Validate a current key. |
| EP_INACTIVE | KDS | Indicate if the EP is inactive. |
| EP_INVALID | KDS | Invalidate a current key. |
| EP_INFO | KDS | Send related downloading mes- |
| | | sage. |
| COMPLETE | EP | Finish downloading. |

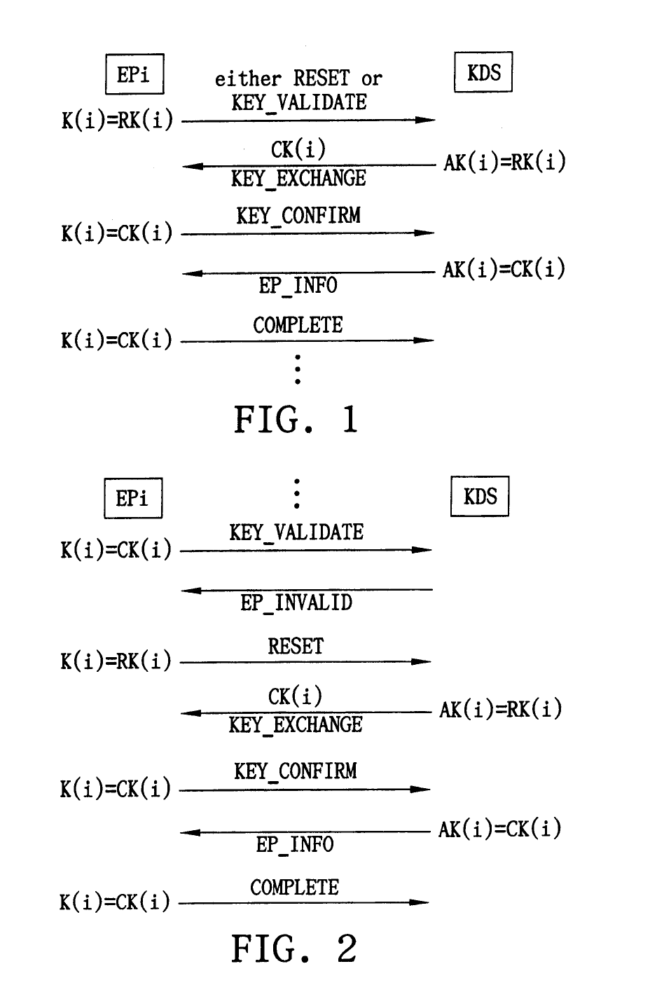

FIG. 1 is a diagram of message transitions between two cryptographic units in accordance with the preferred embodiment of the present invention. An initial key RK(i) is either pre-configured by factories and permanently stored in the EPi or obtained from the KDS through a manual login. After starting to first connect to the KDS, the EPi sends a reset message RESET, encrypted by the initial key RK(i), to the KDS through broadcast. Once receiving the reset message including the physical address MAC(i) of the EPi, a timestamp of 4 bytes and a one-way hash value, the KDS verifies the received message and also uses the initial key RK(i) to decrypt them. If the verification of the messages is approved, the KDS generates a first key CK(i) and sends a key exchange message KEY_EXCHANGE, which includes the first key CK(i) and is encrypted by the initial key RK(i) to the EPi. Afterward, the EPi replaces the initial key RK(i) with the first key CK(i) in response to the received key exchange message, and meanwhile returns a key confirmation message KEY_CONFIRM. If the key confirmation message is approved, the KDS sends a related downloading message of EP_INFO to allow the EPi retrieving the corresponding information from a destination address and a path specified by the downloading message. After all information is successfully downloaded, the EPi sends a finish message COMPLETE to notify the server to await the coming of a next session.

When the next session starts, the client sends a key validation message KEY_VALIDATE, encrypted by the first key CK(i). If the key validation message is approved, the KDS grants the request of the EPi to send another key exchange message with a second key in place of the first key.

After the communication between the EPi and KDS continues for several sessions, the EPi sends a key validation message encrypted by the current key K(i) to the KDS, as shown in FIG. 2. Unfortunately, if the validation message is disapproved by the KDS because of the errors existing in its certain packets, the KDS returns a key invalidation message EP_INVALID. Afterward, the EPi continuously sends a reset message of RESET encrypted by the initial key RK(i) to access the KDS. Referring to FIG. 2, the succeeding message transitions from KEY_EXCHANGE to COMPLETE are the same as the corresponding transitions in FIG. 1.

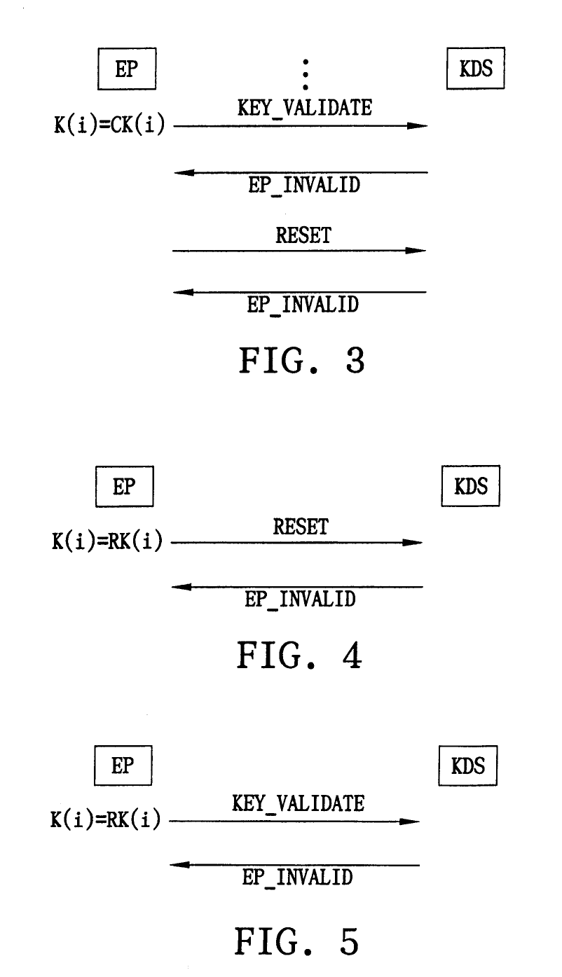

Please refer to FIG. 3, in comparison with the case in FIG. 2, after sending a reset message RESET, encrypted by the initial key RK(i), to access the KDS, the EPi is not recognized and is notified with an inactive EP message EP_INVALID by the KDS.

Referring to FIG. 4, if the EPi sends a reset message RESET, encrypted by the initial key RK(i), to access the KDS. Unfortunately, the EPi is not recognized and is notified with an inactive EP message EP_INVALID by the KDS.

As shown in the last case of FIG. 5, after some sessions, the EPi sends a key validation message KEY_VALIDATE, encrypted by the initial key RK(i), to the KDS, but in vain. The EPi is not recognized and is also notified with an inactive EP message EP_INVALID by the KDS.

The packet structures of all aforesaid messages are summarized in Table 2. Each packet data includes a message ID, field 1 and field 2. All main data including cryptographic keys, address information, timestamp data, etc., are stored in Field 1, and one-way hash values are stored in Field 2.

TABLE 2
Packet
Structure of Mes-
sages

| Message ID | Field 1 | Field 2 |
|---|---|---|
| RESET | E(RK(i), MAC(i)(6 bytes) | HASH(RK(i)) |
| | +timestamp(4 bytes)) | |
| KEY_EXCHANGE | E(AK(i), CK(i)) | HASH(AK(i)) |
| KEY_CONFIRM | E(CK(i), MAC(i)(6 bytes) | HASH(CK(i)) |
| | +timestamp(4 bytes)) | |
| KEY_VALIDATE | E(K(i), MAC(i)(6 bytes) | HASH(K(i)) |
| | +timestamp(4 bytes)) | |
| EP_INACTIVE | N/A | |
| EP_INVALID | N/A | |
| EP_INFO | E(CK(i), Address(4 bytes)+ Path | HASH(CK(i)) |
| | (32 bytes)) | |
| COMPLETE | E(K(i), MAC(i)(6 bytes) | HASH(K(i)) |
| | +timestamp(4 bytes)) | |

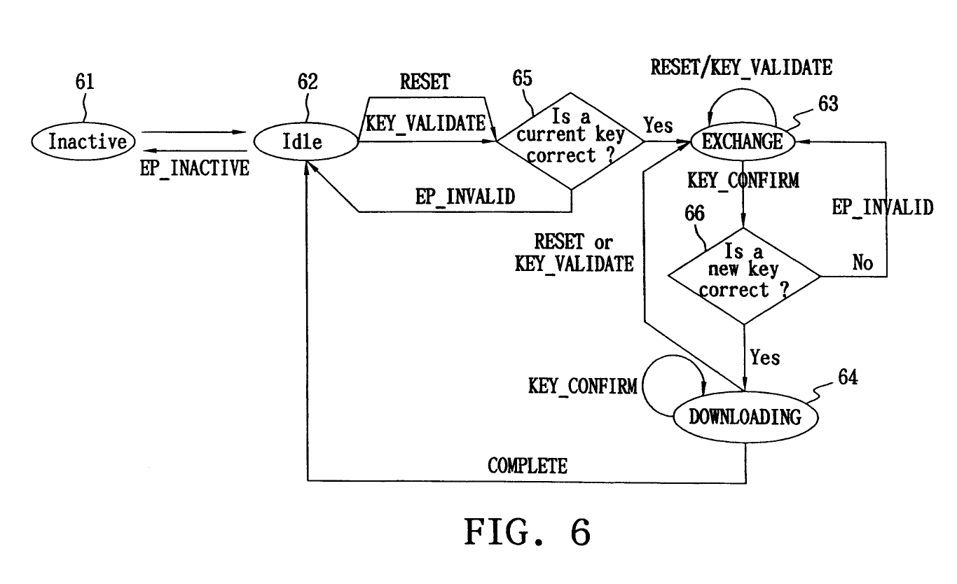

FIG. 6 is a diagram of state transitions regarding the server in accordance with the present invention. Four states of the EPi are monitored by the KDS, which are inactive state 61, idle state 62, exchange state 63 and downloading state 64. When the EPi is at the idle state, it can decide to communicate with the KDS by means of the transmission of the reset message or the key validation message. However, the EPi is considered as an inactive endpoint after all efforts fail to access the KDS. As shown in Step 65, if the KDS verifies the transmitted messages from the EPi, the EPi is changed into the exchange state; otherwise, the EPi receives a disapproval message EP_INVALID from the KDS. When the EPi is at the exchange state, it can send the reset message or the key validation message to the KDS to restore the communication with the KDS. After the key exchange is done, the KDS needs to check whether the EPi correctly receives the new key within the Step 66. If the key confirmation fails to be approved, then the exchange state will still appear. Otherwise, the downloading state is a coming state. After all data are downloaded from a destination, such as an auto-provisioning server, the downloading state is changed into the idle state. The aforesaid transition of states and messages are summarized in Table 3.

TABLE 3
State Tran-
sition Table
for
KDS

STATE /

| MESSAGE | INACTIVE | EXCHANGING | DOWNLOADING | IDLE |
|---|---|---|---|---|
| RESET | INACTIVE / | EXCHANGING / | EXCHANGING / | EXCHANGING / |
| (Correct) | EP_INACTIVE | KEY_EXCHANGE | KEY_EXCHANGE | KEY_EXCHANGE |
| KEY_CONFIRM | INACTIVE / | DOWNLOADING / | DOWNLOADING / | IDLE / |
| (Correct) | EP_INACTIVE | EP_INFO | EP_INFO | |
| KEY_VALIDATE | INACTIVE / | EXCHANGING / | EXCHANGING / | EXCHANGING / |
| (Correct) | EP_INACTIVE | KEY_EXCHANGE | KEY_EXCHANGE | KEY_EXCHANGE |
| COMPLETE | INACTIVE / | IDLE / | IDLE / | IDLE / |
| (Correct) | EP_INACTIVE | | | |
| RESET | INACTIVE / | EXCHANGING / | DOWNLOADING / | IDLE / |
| (Incorrect) | EP_INACTIVE | EP_INVALID | EP_INVALID | EP_INVALID |
| KEY_CONFIRM | INACTIVE / | EXCHANGING / | DOWNLOADING / | IDLE / |
| (Incorrect) | EP_INACTIVE | EP_INVALID | EP_INVALID | EP_INVALID |
| KEY_VALIDATE | INACTIVE / | EXCHANGING / | DOWNLOADING / | IDLE / |
| (Incorrect) | EP_INACTIVE | EP_INVALID | EP_INVALID | EP_INVALID |
| COMPLETE | INACTIVE / | EXCHANGING / | DOWNLOADING / | IDLE / |
| (Incorrect) | EP_INACTIVE | EP_INVALID | EP_INVALID | EP_INVALID |

In Table 3, the uppermost row shows four states, and the leftmost column shows various messages and their corresponding checked results. For example, supposing that the reset message of RESET is correct after the KDS verifies it, if the current EPi is at downloading state, then it is changed into exchanging state and sends a key exchange message KEY_EXCHANGE to the KDS. In addition to the application of the APS, the present invention can also be applied to any data exchange system in secure demand.

The above-described embodiments of the present invention are intended to be illustrative only. Numerous alternative embodiments may be devised by persons skilled in the art without departing from the scope of the following claims.

1. A method of secure data exchange between a master cryptographic unit and a slave cryptographic unit, comprising the steps of:
sending either a reset message or a key validation message to request the master cryptographic unit to validate a key held by the slave cryptographic unit; and
forwarding a key exchange message, which includes a new key encrypted through the key held by the slave cryptographic unit, from the master cryptographic unit to the slave cryptographic unit.

2. The method of secure data exchange of claim 1, further comprising a step of sending a key confirmation message to notify the master cryptographic unit that the new key is correctly received by the slave cryptographic unit.

3. The method of secure data exchange of claim 2, further comprising the steps of:
responding to the key confirmation message with a downloading message to allow the slave cryptographic unit retrieving requested information; and
sending a finish message to the master cryptographic unit after the requested information is completely downloaded.

4. The method of secure data exchange of claim 1, wherein the reset message requests the master cryptographic unit to validate an initial key held by the slave cryptographic unit.

5. The method of secure data exchange of claim 4, wherein the initial key is either pre-configured by factories and permanently stored in the slave cryptographic unit or obtained from the master cryptographic unit through a manual login.

6. The method of secure data exchange of claim 1, further comprising a step of notifying the slave cryptographic unit that the key is invalid after the key validation message is sent.

7. The method of secure data exchange of claim 6, further comprising a step of sending the rest message to request the master cryptographic unit to validate an initial held by the slave cryptographic unit.

8. The method of secure data exchange of claim 3, further comprising the steps of:
sending another key validation message to request the master cryptographic unit to validate the new key held by the slave cryptographic unit; and
forwarding another key exchange message, which includes a renewed key encrypted through the new key held by the slave cryptographic unit.

9. The method of secure data exchange of claim 1, further comprising a step of notifying the slave cryptographic unit that the key is invalid after the resent message is sent.

10. The method of secure data exchange of claim 1, wherein the master cryptographic unit is a key distribution server.

11. The method of secure data exchange of claim 10, wherein the key distribution server is included in an automatic provisioning system.

12. The method of secure data exchange of claim 10, wherein the slave cryptographic unit is a client.

13. The method of secure data exchange of claim 10, wherein the reset message includes an initial key, a physical address of the slave cryptographic unit, timestamp data and hash data.

14. The method of secure data exchange of claim 10, wherein the key validation message includes the key, a physical address of the slave cryptographic unit, timestamp data and hash data.
